(19) United States
(12) Patent Application Publication
(10) Pub. No.: US 2007/0094476 A1
(43) Pub. Date: Apr. 26, 2007

(54) Updating multiple levels of translation lookaside buffers (TLBs) field

(76) Inventors: Victor Roberts Augsburg, Cary, NC (US); Thomas Andrew Sartorius, Raleigh, NC (US); James Norris Dieffenderfer, Apex, NC (US); Jeffrey Todd Bridges, Raleigh, NC (US)

Correspondence Address: QUALCOMM INCORPORATED, 5775 MOREHOUSE DR., SAN DIEGO, CA, 92121, US

(21) Appl. No.: 11/254,898

(22) Filed: Oct. 20, 2005

(51) Int. Cl. G06F 12/00

(52) U.S. Cl. 711/207

(57) ABSTRACT

An apparatus includes a memory configured to store data, a lower level TLB, an upper level TLB, and a TLB controller. The lower level TLB and the upper level TLB are configured to store a plurality of entries, each of the entries containing an address translation information that allows a virtual address to be translated into a corresponding physical address. The TLB controller retrieves from a page table in the memory an address translation information for a desired virtual address, if the desired virtual address generates a TLB miss from the lower level TLB and from the upper level TLB, Using a single TLB write instruction, the TLB controller updates both the lower level TLB and the upper level TLB by writing the address translation information, retrieved from the page table, into the lower level TLB as well as into the upper level TLB.

The present invention relates to translation lookaside buffers (TLBs).

### BACKGROUND

In a processor that supports paged virtual memory, data may be specified using virtual addresses (also referred to as “effective” or “linear” addresses) that occupy a virtual address space of the processor. The virtual address space may typically be larger than the size of the actual physical memory in the system. The operating system in the processor may manage the physical memory in fixed size blocks called pages.

To translate virtual page addresses into physical page addresses, the processor may search page tables stored in the system memory, which may contain the necessary address translation information. Since these searches (or “page table walks”) may typically involve memory accesses, unless the page table data is in a data cache, these searches may be time-consuming.

The processor may therefore perform address translation using one or more translation lookaside buffers (TLBs). A TLB is an address translation cache, i.e. a small cache that stores recent mappings from virtual addresses to physical addresses. The processor may cache the physical address in the TLB, after performing the page table search and the address translation. The contents of a TLB may typically include commonly referenced virtual page addresses, as well as the physical page address associated therewith. There may be separate TLBs for instruction addresses (referred to as “instructions TLB” or “I-TLB”) and for data addresses (referred to as “data-TLB” or “D-TLB”).

In order to increase the efficiency of TLB accesses, multiple levels of TLBs may be used and implemented, by analogy to multiple levels of memory cache. A lower level TLB may typically be smaller and faster, compared to one or more upper level TLBs. When a TLB miss occurs in both a lower level TLB and an upper level TLB, the upper level TLB may typically be updated, as a result of a page table walk.

Generally, the lower level TLB may not be updated with the address translation information retrieved from the page table in the physical memory. A subsequent reference to the lower level TLB would then result in a TLB miss, requiring a search of the upper level TLB for the desired address translation information. There may be an undesirable latency, however, that is associated with the miss in the lower level TLB and with the resulting search of the upper level TLB.

### SUMMARY

A computer-readable medium has stored therein computer-readable instructions for a processor. The instructions, when read an implemented by the processor, cause the processor to access a physical memory to retrieve address translation information for a virtual address that generates a TLB miss signal for both a lower level TLB and an upper level TLB. The instructions also cause the processor to update both the lower level TLB and the upper level TLB using a single TLB write instruction, by writing the address translation information retrieved from the memory into both the lower level TLB and the upper level TLB.

A method of updating more than one level of TLB includes accessing a memory to retrieve address translation information for a virtual address. The method includes updating both a lower level TLB and an upper level TLB using a single TLB write instruction, by writing the address translation information retrieved from the memory into both the lower level TLB and the upper level TLB.

An apparatus includes a memory; a lower level TLB and an upper level TLB; and a TLB controller. The lower level TLB and the upper level TLB are configured to store a plurality of entries, each of the entries containing address translation information that allows a virtual address to be translated into a corresponding physical address. The TLB controller is configured to retrieve from the memory an address translation information for a desired virtual address, if the desired virtual address generates a TLB miss from the lower level TLB and from the upper level TLB. The TLB controller is further configured to update both the lower level TLB and the upper level TLB using a single TLB write instruction, by writing the address translation information retrieved from the memory into both the lower level TLB and the upper level TLB using the single TLB write instruction.

### BRIEF DESCRIPTION OF THE DRAWINGS

FIG. 1 schematically illustrates a TLB that operates in a virtual memory system.

FIG. 2 is a schematic diagram of an example of an address translation system having an upper level TLB and a lower level TLB, and a TLB controller configured to update both levels of TLB as a result of a single TLB write operation.

FIG. 3 is a schematic flow chart illustrating a method of updating more than one level of TLB.

### DETAILED DESCRIPTION

The detailed description set forth below in connection with the appended drawings is intended to describe various embodiments of a method and system configured to update multiple levels of TLB, but is not intended to represent the only possible embodiments. The detailed description includes specific details, in order to permit a thorough understanding of what is described. It should be appreciated by those skilled in the art, however, that these specific details may not be included in some of the described embodiments. In some instances, well-known structures and components are shown in block diagram form, in order to more clearly illustrate the concepts that are being explained.

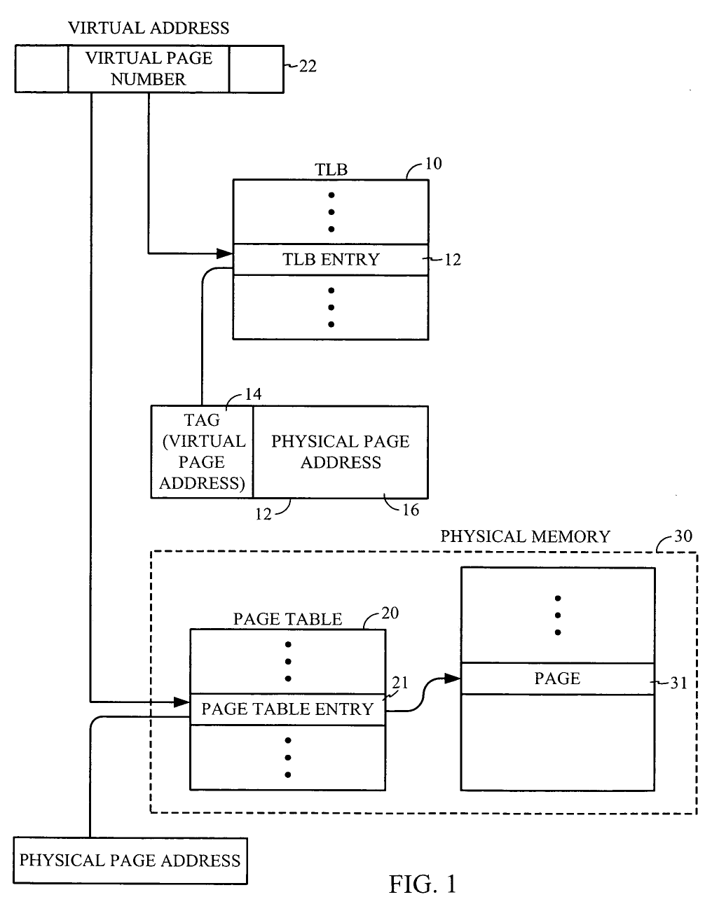

FIG. 1 schematically illustrates the operation in a virtual memory system of a translational lookaside buffer (TLB) 10, in conjunction with a page table 20 included in a physical memory 30. As known in the art, in virtual memory systems mappings (or translations) may typically be performed between a virtual (or “linear”) address space and a physical address space. A virtual address space typically refers to the set of all virtual addresses 22 generated by a processor. A physical address space typically refers to the set of all physical addresses for the data residing in the physical memory 30, i.e. the addresses that may be provided on a memory bus to write to or read from a particular location in the physical memory 30.

In a paged virtual memory system, it may be assumed that the data is composed of fixed-length units commonly referred to as pages 31. The virtual address space and the physical address space may be divided into blocks of contiguous page addresses, each virtual page address providing a virtual page number, and each corresponding physical page address indicating the location within the memory 30 of a particular page 31 of data. A typical page size may be about 4 kilobytes, for example, although different virtual paged memory systems may use different page sizes. The page table 20 in the physical memory 30 may contain the physical page addresses corresponding to all of the virtual page addresses of the virtual memory system, i.e. may contain the mappings between virtual page addresses and the corresponding physical page addresses, for all the virtual page addresses in the virtual address space. Typically, the page table 20 may contain a plurality of page table entries (PTEs) 21, each PTE 21 pointing to a page 31 in the physical memory 30 that corresponds to a particular virtual address.

Accessing the PTEs 21 stored in the page table 20 in the physical memory 30 may require memory bus transactions, which may be costly in terms of processor cycle time and power consumption. The number of memory bus transactions may be reduced by accessing the TLB 10, rather than the physical memory 30. As explained earlier, the TLB 10 is an address translation cache that stores recent mappings between virtual and physical addresses. The TLB 10 typically contains a subset of the virtual-to-physical address mappings that are stored in the page table 20. A TLB 10 may typically contain a plurality of TLB entries 12. Each TLB entry 12 may have a tag field 14 and a data field 16. The tag field 14 may include some of the high order bits of the virtual page addresses as a tag. The data field 16 may indicate the physical page address corresponding to the tagged virtual page address.

When an instruction has a virtual address 22 that needs to be translated into a corresponding physical address, during execution of a program, the TLB 10 may be accessed to look up the virtual address 22 among the TLB entries 12 stored in the TLB 10. The virtual address 22 typically includes a virtual page number, which may be used in the TLB 10 to look up the corresponding physical page address.

If the TLB 10 contains, among its TLB entries, the particular physical page address corresponding to the virtual page number contained in the virtual address 22 presented to the TLB, a TLB “hit” occurs, and the physical page address can be retrieved from the TLB 10. If the TLB 10 does not contain the particular physical page address corresponding to the virtual page number in the virtual address 22 presented to the TLB, a TLB “miss” occurs, and a lookup of the page table 20 in the physical memory 30 may have to be performed. Once the physical page address is determined from the page table 20, the physical page address corresponding to the virtual page address may be loaded into the TLB 10, and the TLB 10 may be accessed once again with the virtual page address 22. Because the desired physical page address has been loaded in the TLB 10, the TLB access results in a TLB “hit” this time, and the recently loaded physical page address may be generated at an output of the TLB 10.

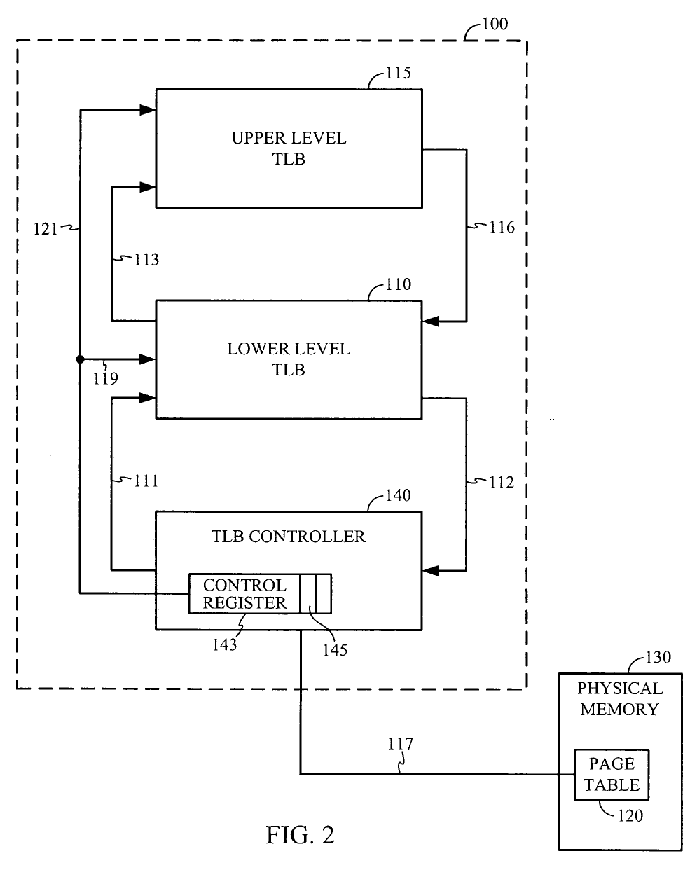

FIG. 2 is a functional diagram of an example of an address translation system 100, which is configured to update more than one level of TLB as a result of single TLB write operation. In overview, the address translation system 100 may include a lower level TLB 110; an upper level TLB 115; and a TLB controller 140 that controls the operation of both the lower level TLB 110 and the upper level TLB 115. The address translation system 100 may be connected to a physical memory 130, which may include a page table 120. The TLB controller 140 may be part of a CPU (central processing unit) in a processor. Alternatively, the TLB controller 140 may be located within a core of a processor, and/or near the CPU of a processor. The TLB controller 140 may include TLB managing software that controls the accesses to both levels of TLB.

By analogy to multiple levels of cache that are commonly used for example in memory caches, the efficiency of address translation operations may be increased by using the lower level TLB 110 in conjunction with the upper level TLB. The lower level TLB 110 may typically be smaller than the upper level TLB 115, and may contain fewer TLB entries, thereby providing a short access time to the frequently used address data. Although for simplicity only a single upper level TLB 115 is shown in FIG. 2, it should be understood that a plurality of upper level TLBs may be included in the address translation system 100, each increased level of TLB typically being larger than the previous level of TLB, and having progressively increasing number of TLB entries.

The TLB managing software in the TLB controller 130 may cause the lower level TLB 110 to be initially accessed and searched, to look for an address translation information for a desired virtual address, as indicated in FIG. 2 by an arrow labeled with reference numeral 111. If a TLB hit occurs in the lower level TLB 110, the software in the TLB controller 130 may cause the search result to be retrieved, as indicated by the arrow labeled with reference numeral 112. If a TLB miss occurs in the lower level TLB 110, the software may implement a search of the upper level TLB 115. The search of the upper level TLB 115 is indicated in FIG. 2 by an arrow labeled with reference numeral 113. The upper level TLB 115 may typically contain many more TLB entries, compared to the lower level TLB 110.

If the search 113 of the upper level TLB 115 results in a TLB hit, the result of the search may be retrieved and loaded into the lower level TLB, as indicated in FIG. 2 by an arrow labeled with reference numeral 116. The search 113 of the upper level TLB 115 may still result in a miss, however, in which case the software in the TLB controller 140 may implement a search of the page table 120 in the physical memory 130, in order to retrieve the desired physical page address information. The search of the page table 120 is indicated in FIG. 2 by an arrow labeled with reference numeral 117.

If the desired page does exist in the physical memory 130, the relevant address translation information may be loaded from the page table 120 into the upper level TLB 115. This means that the desired address translation information (i.e. the mapping between the virtual address and the corresponding physical address) may be written into the upper level TLB 115, as indicated in FIG. 2 by an arrow labeled with reference numeral 121. If the desired page is not present in the memory 130, a page fault may occur, and the operating system may be notified with an exception.

Once the upper level TLB 115 is updated, the TLB managing software may cause the TLB controller 140 to repeat the TLB reference process. The instruction having the virtual address that initially produced a miss in both TLBs (110 and 115) may be re-fetched, and the TLB reference process may be performed all over again, starting with the lower level TLB 110.

If the lower level TLB 110 is not updated, and only the upper level TLB 120 is updated with the address translation information retrieved from the page table 120, a TLB miss would occur in the lower TLB 110, in the subsequent TLB reference process. As a result, a search of the upper level TLB 115 would be necessary, in order to retrieve the desired address translation information. An undesirable latency would be associated with the miss in the lower level TLB 110, and with the resulting search of the upper TLB 115.

In the illustrated embodiment of the address translation system 100, the TLB controller 140 includes software that causes the TLB controller 140 to update both the lower level TLB 110 and the upper level TLB 115 using the address translation information that was retrieved from the page table 120. In particular, the software in the TLB controller 140 causes the address translation information, retrieved from the page table 120, to be written into both levels of TLB, as a result of a single TLB write instruction. In FIG. 2, the update of the lower level TLB 110 is indicated by an arrow labeled with reference numeral 119. In the illustrated embodiment, the TLB controller 140 is configured to allow for an update of the lower level TLB 110, whenever an update 121 of the upper level TLB 115 occurs.

As a result of updating the lower level TLB 110 as well as the upper level TLB 115, a TLB hit may now result, instead of a TLB miss, when access to the first level TLB 110 is attempted for the second time around, i.e. after the instruction containing the virtual address (that was missing in both levels of TLB during the initial accesses of the TLBs) is re-fetched. In this way, the need to perform another search of the upper level TLB 115 may be obviated. Also, the latency associated with a miss in the lower level TLB 110 during the second (repeated) TLB reference process, and with the resulting search of the upper level TLB 120, may be eliminated.

As illustrated in FIG. 2, the TLB controller 140 may include a control register 143 that has a configuration bit 145. The configuration bit 145 may control whether or not the TLB write operation (indicated by reference numeral 121) should be performed. The configuration bit 145 may also select which levels of TLB the single TLB write operation should be performed on, so as to update the selected levels of TLB with the address translation information retrieved from the page table.

In another embodiment (not shown) of the TLB controller 140, the selection of the levels of TLB onto which the retrieved address translation information is written may be controlled by the value being written from the page table. In other words, the value retrieved from the page table may contain, in addition to the desired address translation information, information relating to the selection of levels of TLB onto which the TLB write operation for the retrieved address translation information is to be performed.

The TLB controller 140 may contain a computer-readable medium having stored therein computer-readable instructions. These computer-readable instructions, when read and executed by a processor, may cause the processor to access the page table 120 in the physical memory 130 to retrieve address translation information for a virtual address which generated a TLB miss from both the lower level TLB 110 and from the upper level TLB 115. The computer-readable instructions may cause the processor to write the address translation information that was retrieved from the page table 120 into both the lower level TLB 110 and the upper level TLB 115, thereby updating both levels of TLB, in response to a single TLB write instruction.

The TLB controller 140 may include a control register 143 having a configuration bit 145. The computer-readable medium may have stored therein additional computer-readable instructions, which, when read and implemented by the processor, may cause the configuration bit 145 to determine whether or not the TLB write operation that writes the retrieved address translation information into the lower level TLB and the upper level TLB should occur.

The computer-readable medium may have stored therein additional computer-readable instructions, which, when read and implemented by the processor, may cause the configuration bit 145 to select, from a plurality of levels of TLB within the processor, two or more levels of TLB that are to be updated as a result of a single TLB write instruction. In other words, these additional computer-readable instructions may cause the configuration bit to select those levels of TLB onto which the address translation information retrieved from the page table should be written, as a result of the single TLB write instruction.

The computer-readable medium may have stored therein additional computer-readable instructions, which, when read and implemented by the processor, may cause the processor to read, from the address translation information retrieved from the page table, additional information relating to a selection of two or more levels of TLB that are to be updated, as a result of a single TLB write instruction. In other words, these additional computer-readable instructions, when read and implemented by the processor, may cause the processor to read from the retrieved address translation information itself, the selection of the TLB levels onto which the retrieved address translation information should be written.

The computer-readable medium may have stored therein additional computer-readable instructions, which, when read and implemented by the processor, may cause the processor to initially access the lower level TLB 110 to search for an address translation information for a desired virtual address, and to access and search the upper level TLB 115 if the address translation information for the desired virtual address is missing from the lower level TLB 110, i.e. if the desired virtual address generates a TLB miss when presented to the lower level TLB 110. The additional computer-readable instructions may further cause the processor to access the page table 120 in the physical memory 130 to retrieve the address translation information for the desired virtual address, if the address translation information is missing from the upper level TLB 115, i.e. if the desired virtual address generates a TLB miss when presented to the upper level TLB 115.

While the embodiment of the address translation system 100 illustrated in FIG. 2 shows only two levels of TLB, other embodiments (not shown) of address translation systems may include more than two levels of TLB. These address translation systems may include a plurality of levels of TLB, each level of TLB including TLB entries that may store address translation information for virtual addresses. The TLB controller in these address translation systems may be configured to access each of the multiple levels of TLB in turn, starting from the lowest level of TLB, and progressing onto the uppermost level of TLB. The TLB controller may be configured to access the page table in the physical memory, if the address translation information for a desired virtual address is missing in all of the plurality of levels of TLB, and to retrieve the address translation information for the desired virtual address from the page table in the physical memory. The TLB controller may be further configured to update all of the plurality of levels of TLB with the address translation information that has been retrieved from the page table in the physical memory.

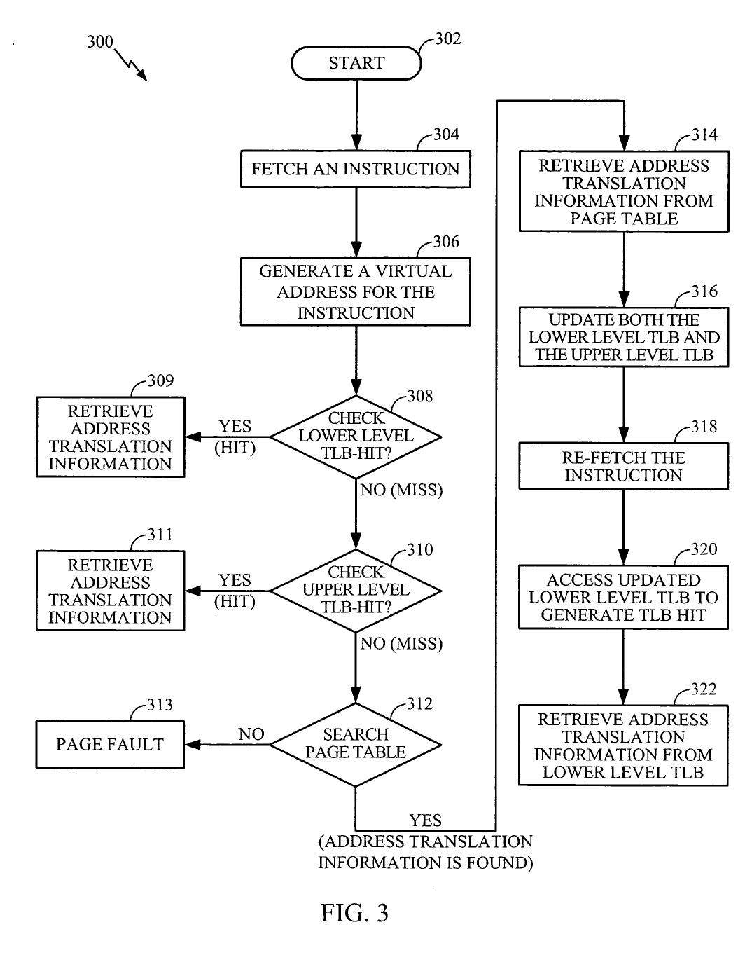

FIG. 3 is a flow diagram of a method 300 of updating more than one level of TLB. The method 300 starts in step 302. In step 304, an instruction may be fetched so that execution of the instruction can begin. In step 306, a virtual address may be generated for the fetched instruction. In step 308, a TLB controller may access a lower level TLB, to search in the lower level TLB for address translation information for the virtual address generated in step 306. If the address translation information does exist in the lower level TLB, the TLB controller may retrieve the address translation information from the lower level TLB, in step 309. If the desired address translation information does not exist in the lower level TLB, then a TLB miss may occur. The TLB controller may receive an indication of a TLB miss from the lower level TLB, i.e. receive a “TLB miss” signal. The TLB controller may then proceed to check an upper level TLB in step 310, to determine if the desired entry exists in the upper level TLB.

If the desired address translation information exists in the upper level TLB, the TLB controller may retrieve the address translation information from the upper level TLB, in step 311. If the desired address translation information does not exist in the upper level TLB, a TLB miss may occur in the upper level TLB. The TLB controller may receive an indication of the TLB miss from the upper level TLB, i.e. receive a “TLB miss” signal from the upper level TLB. The TLB controller may then proceed, in step 312, to access the physical memory to search the page table for the desired entry. If the desired address translation information is found in the page table, the TLB controller may retrieve the information from the page table, in step 314. If the desired address translation information is not found in the page table, the TLB controller may cause a page fault to occur, in step 313.

After the TLB controller retrieves the desired entry from the page table in step 314, the TLB controller may write the address translation information (retrieved from the page table) in both the lower level TLB and the upper level TLB in step 316, by executing a single TLB write instruction. In other words, the TLB controller may update both levels of TLB by executing the single TLB write instruction. The TLB reference process may then be performed all over again, starting from step 318, in which the instruction may be re-fetched. In step 320, the lower level TLB may be accessed once more. This time, since the lower level TLB has already been updated with the address translation information retrieved from the page table, a TLB hit may occur. The TLB controller may retrieve the desired address translation information from the lower level TLB, in step 322.

The method 300 may include the act (not shown) of reading a configuration bit in the TLB controller to determine which levels of TLB should be updated using the single TLB write instruction. The method 300 may include the act (not shown) of reading the value retrieved from the page table to determine which levels of TLB should be updated using a single TLB write instruction.

While the method illustrated in FIG. 3 shows only two levels of TLB (i.e., a lower level TLB and an upper level TLB), other methods (not illustrated) of updating TLBs may involve more than two levels of TLBs.

In sum, a system and method have been described for eliminating the latency that is associated with a miss in a lower level TLB that occurs during a re-fetch of an instruction, the miss being caused by the lower level TLB not being updated when the upper level TLB is updated. The miss in the lower level TLB requires a search in an upper level TLB, which results in additional latency. By updating the lower level TLB at the same time the upper level TLB is updated, a subsequent reference to the lower level TLB produces a hit rather than a miss, obviating the need to bring in the entry from the upper level TLB.

The previous description of the disclosed embodiments is provided to enable any person skilled in the art to make or use the method and system described above. Various modifications to these embodiments will be readily apparent to those skilled in the art, and the generic principles defined herein may be applied to other embodiments without departing from the spirit or scope of what has been described. Thus, the method and system described above are not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference, and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A computer-readable medium having stored therein computer-readable instructions for a processor, wherein the instructions, when read and implemented by the processor, cause the processor to:
access a physical memory to retrieve address translation information for a virtual address that generates a TLB miss signal for both a lower level TLB and an upper level TLB; and
update both the lower level TLB and the upper level TLB using a single TLB write instruction, by writing the address translation information retrieved from the memory into both the lower level TLB and the upper level TLB.

2. The computer-readable medium of claim 1, wherein the computer-readable medium has stored therein further computer-readable instructions for the processor, and wherein said further instructions, when read and implemented by the processor, cause the processor to initially access the lower level TLB to search for an address translation information for a virtual address, to access and search an upper level TLB if the virtual address generates a TLB miss from the lower level TLB, and to access a page table in the physical memory to retrieve the address translation information for the desired virtual address, if the virtual address generates a TLB miss from the upper level TLB.

3. The computer-readable medium of claim 1, wherein the processor includes a control register having a configuration bit, wherein the computer-readable medium has stored therein further computer-readable instructions for the processor, and wherein said further instructions, when read and implemented by the processor, cause the configuration bit to determine whether or not a TLB write operation of the retrieved address translation information should occur.

4. The computer-readable medium of claim 3, wherein the processor includes a plurality of levels of TLB, and wherein said further instructions, when read and implemented by the processor, cause the configuration bit to select, from the plurality of levels of TLB, the lower level TLB and the upper level TLB to be updated in response to the single TLB write instruction.

5. The computer-readable medium of claim 1, wherein the processor includes a plurality of levels of TLB, wherein the computer-readable medium has stored therein further computer-readable instructions for the processor, and wherein said further instructions, when read and implemented by the processor, cause the processor to use the address translation information retrieved from the memory to select, from the plurality of levels of TLB, the lower level TLB and the upper level TLB to be updated in response to the single TLB write instruction.

6. A method of updating more than one level of TLB, the method comprising:
accessing a memory to retrieve the address translation information for a virtual address; and
updating both a lower level TLB and an upper level TLB using a single TLB write instruction, by writing the address translation information retrieved from the memory into both the lower level TLB and the upper level TLB.

7. The method of claim 6, further comprising the act of receiving from the lower level TLB and from the upper level TLB an indication of a TLB miss for a virtual address;

8. The method of claim 5, further comprising the act of accessing the lower level TLB and the upper level TLB to search for address translation information for the virtual address, the address translation information allowing the virtual address to be translated into a physical address.

9. The method of claim 6, wherein the memory is configured to store data in a plurality of pages, wherein the memory contains a page table configured to store information about a location within the memory of each one of the plurality of pages, and wherein the act of accessing the memory to retrieve the address translation information comprises retrieving the address translation information from the page table.

10. An apparatus comprising:
a memory;
a lower level translation lookaside buffer (TLB) and an upper level TLB, the lower level TLB and the upper level TLB being configured to store a plurality of entries, each of the entries containing address translation information that allows a virtual address to be translated into a corresponding physical address; and
a TLB controller configured to retrieve from the memory an address translation information for a desired virtual address, if the desired virtual address generates a TLB miss from the lower level TLB and from the upper level TLB, the TLB controller further configured to update both the lower level TLB and the upper level TLB using a single TLB write instruction, by writing the address translation information retrieved from the memory into both the lower level TLB and the upper level TLB using the single TLB write instruction.

11. The apparatus of claim 10, wherein the memory is configured to store data in a plurality of pages, and wherein the memory contains a page table configured to store information about a location within the memory of each one of the plurality of pages.

12. The apparatus of claim 10, wherein the TLB controller is further configured to initially access the lower level TLB to search for the desired address translation information, to access and search the upper level TLB if the desired translation information is missing from the lower level TLB, and to access the memory to retrieve the desired address translation information, if the desired address translation information is missing from the upper level TLB.

13. The apparatus of claim 10, wherein the TLB controller comprises a control register having a configuration bit, and wherein the configuration bit is configured to select, from a plurality of levels of TLB, the lower level TLB and the upper level TLB to be updated using a single TLB write instruction.
